(19) United States
(12) Patent Application Publication
(10) Pub. No.: US 2009/0122462 A1
(43) Pub. Date: May 14, 2009

(54) Electronic Device, Multilayer Ceramic Capacitor and the Production Method Thereof

(75) Inventors: Kazutaka Suzuki, Narita-shi (JP); Shigeki Sato, Narita (JP)

Correspondence Address: OLIFF & BERRIDGE, PLC, P.O. BOX 320850, ALEXANDRIA, VA, 22320-4850, US

(73) Assignee: TDK Corporation, Tokyo (JP)

(21) Appl. No.: 11/597,561

(22) PCT Filed: May 26, 2005
(86) PCT No.: PCT/JP05/09648

§ 371 Date: Nov. 27, 2006

(30) Foreign Application Priority Data
May 31, 2004 (JP) 2004-161351

(51) Int. Cl. H01G 4/12; B32B 37/06

(52) U.S. Cl. 361/321.2; 156/89.12; 156/89.14

(57) ABSTRACT

An electronic device, such as a multilayer ceramic capacitor, and a method for producing the electronic device having an internal electrode layer and a dielectric layer, comprising a step of forming a pre-fired internal electrode thin film including a conductive component and a dielectric component, a step of stacking green sheets to be dielectric layers after firing and the internal electrode thin films, and a step of firing a multilayer body of the green sheets and the internal electrode thin films are provided: by which grain growth of conductive particles in a firing step can be suppressed, spheroidizing in the internal electrode layers and breaking of electrodes can be effectively prevented, and a decline of the capacitance can be effectively suppressed even when a thickness of each internal electrode layer is made thinner.

### BACKGROUND OF THE INVENTION

1. Field of the Invention

The present invention relates to an electronic device, a multilayer ceramic capacitor and the production method and, particularly, relates to an electronic device and a multilayer ceramic capacitor capable of responding to attaining a thinner layers and downsizing.

2. Description of the Related Art

A multilayer ceramic capacitor as an example of electronic devices comprises an element body having a multilayer structure, wherein a plurality of dielectric layers and internal electrode layers are alternately arranged, and a pair of external terminal electrodes formed on both ends of the element body.

The multilayer ceramic capacitor is produced by forming a pre-fired element body by alternately stacking a plurality of pre-fired dielectric layers and pre-fired internal electrode layers exactly by necessary numbers, firing the result and, then, forming a pair of external terminal electrodes on both end portions of the fired element body.

A ceramic green sheet, etc. produced by the sheet method or the stretching method, etc. is used for the pre-fired dielectric layers. The sheet method is a method for producing by applying dielectric slurry including a dielectric powder, binder, plasticizer and organic solvent, etc. to a carrier sheet, such as PET, by using the doctor blade method, etc. and heating to dry. The stretching method is a method for producing by performing biaxial stretching on a film-shaped molded body obtained by extrusion molding of a dielectric suspending solution obtained by mixing dielectric powder and a binder in a solvent.

The pre-fired internal electrode layers are formed by using the printing method for printing internal electrode paste including a metal powder and a binder on the ceramic green sheet explained above in a predetermined pattern, or by the thin film formation method using plating, vapor deposition or sputtering, etc. to form a conductive thin film in a predetermined pattern on the green sheet. Particularly, when forming by a conductive thin film obtained by the thin film formation method, the internal electrode layer can be made thinner, so that a multilayer ceramic capacitor can be made to be more compact and thinner with a larger capacity.

As explained above, when producing a multilayer ceramic capacitor, the pre-fired dielectric layers and pre-fired internal electrode layers are fired at a time. Therefore, a conductive material included in the pre-fired internal electrode layers is required to have a higher melting point than a sintering temperature of the dielectric powder included in the pre-fired dielectric layers, not to react with the dielectric powder and not to be diffused in the fired dielectric layers.

In recent years, along with downsizing of a variety of electronic devices, multilayer ceramic capacitors to be installed inside the electronic devices have become downsized and come to have a larger capacity. To attain such downsizing and a larger capacity of multilayer ceramic capacitors, the internal electrode layers have been required to be thinner as well as the dielectric layers. As a method of obtaining thinner internal electrode layers, a method of forming the pre-fired internal electrode layers by a conductive thin film obtained by the thin film formation method may be mentioned (for example, the patent article 1: The Japanese Patent Publication No. 3491639).

This patent article 1 discloses a production method of a multilayer ceramic capacitor by forming a second metal layer including ceramic particles by the composite plating method on a first metal layer formed by a thin film formation method. According to the production method disclosed in the article, by forming the second metal layer functioning as an adhesive layer in addition to the first metal layer to be an internal electrode layer after firing, delamination of the internal electrode layer and dielectric layer after firing can be prevented.

However, in this article, the second metal layer is an adhesive layer for preventing delamination and formed by the plating method. Therefore, the second metal layer had to include dielectric particles in a relatively larger content, and the thickness had to be thick.

Also, as a conductive material to be included in the pre-fired internal electrode layers, a base metal nickel is preferably used because of the relatively low price, etc. However, since nickel has a lower melting point comparing with that of the dielectric powder included in the pre-fired dielectric layers, when firing the pre-fired dielectric layers and pre-fired internal electrode layers at a time, there arises a difference in sintering temperatures of the both. In the case where the sintering temperatures are largely different as such, when firing is performed at a high temperature, nickel particles included in the conductive material become spheroidized due to grain growth and cavities arise at arbitrary places, consequently, it becomes difficult to form fired internal electrode layers in a continuous form. When fired internal electrode layers are not in a continuous form as above, capacitance of the multilayer ceramic capacitor tends to decline.

To suppress grain growth of nickel particles at firing, a method of adding dielectric particles together with the nickel particles to the conductive paste for internal electrode layers has been used. Here, the dielectric particles are added to be a common material. When nickel particles and dielectric particles are included in the conductive paste as such, an adding amount of the dielectric particles with respect to the nickel particles had to be relatively large as 5 wt % or larger or 1.33 mol % or larger to suppress grain growth of the nickel particles.

However, it is generally difficult to disperse dielectric particles and nickel particles uniformly, and the dielectric particles or nickel particles tend to aggregate. Furthermore, aggregated dielectric particles as such grow to be several μm or so by sintering to cause breaking of internal electrode layers. Therefore, there arises a disadvantage that the capacitance declines in any case.

### SUMMARY OF THE INVENTION

An object of the present invention is to provide an electronic device, such as a multilayer ceramic capacitor, capable of suppressing grain growth of conductive particles in a firing stage, effectively preventing spheroidizing of internal electrode layers and breaking of electrodes and effectively suppressing a decline of capacitance, particularly, even when a thickness of the internal electrode layers is made thinner; and a production method thereof.

The present inventors found that, in the production method of an electronic device, such as a multilayer ceramic capacitor, having internal electrode layers and dielectric layers, the above object can be attained by forming a pre-fired internal electrode thin film including a conductive component and a dielectric component, wherein a content of the dielectric component is larger than 0 mol % but not larger than 0.8 mol % or larger than 0 wt % but not larger than 3 wt %, and firing a multilayer body of the pre-fired internal electrode thin films and green sheets; and completed the present invention.

Namely, according to a first aspect of the present invention, there is provided a production method of an electronic device for producing an electronic device including internal electrode layers and dielectric layers, comprising the steps of:

forming a pre-fired internal electrode thin film including a conductive component and a dielectric component;

stacking a green sheet to be a dielectric layer after firing and the pre-fired internal electrode thin film; and

firing a multilayer body of the green sheet and the pre-fired internal electrode thin film;

wherein a content of the dielectric component in the pre-fired internal electrode thin film is larger than 0 mol % but not larger than 0.8 mol % with respect to the entire pre-fired internal electrode thin film.

According to the first aspect of the present invention, there is provided a production method of a multilayer ceramic capacitor for producing a multilayer ceramic capacitor having an element body, wherein internal electrode layers and dielectric layers are alternately stacked, comprising the steps of:

forming a pre-fired internal electrode thin film including a conductive component and a dielectric component;

alternately stacking green sheets to be dielectric layers after firing and the pre-fired internal electrode thin films; and

firing a multilayer body of the green sheets and the pre-fired internal electrode thin films;

wherein a content of the dielectric component in the pre-fired internal electrode thin film is larger than 0 mol % but not larger than 0.8 mol % with respect to the entire pre-fired internal electrode thin film.

Note that in the first aspect of the present invention, the dielectric component in the pre-fired internal electrode thin film is not particularly limited and BaTiO₃, Y₂O₃ and HfO₂, etc. may be mentioned.

According to a second aspect of the present invention, there is provided a production method of an electronic device for producing an electronic device including internal electrode layers and dielectric layers, comprising the steps of:

forming a pre-fired internal electrode thin film including a conductive component and a dielectric component;

stacking a green sheet to be a dielectric layer after firing and the pre-fired internal electrode thin film; and

firing a multilayer body of the green sheet and the pre-fired internal electrode thin film;

wherein a content of the dielectric component in the pre-fired internal electrode thin film is larger than 0 wt % but not larger than 3 wt % with respect to the entire pre-fired internal electrode thin film.

Also, according to the first aspect of the present invention, there is provided a production method of a multilayer ceramic capacitor for producing a multilayer ceramic capacitor having an element body, wherein internal electrode layers and dielectric layers are alternately stacked, comprising the steps of:

forming a pre-fired internal electrode thin film including a conductive component and a dielectric component;

alternately stacking green sheets to be dielectric layers after firing and the pre-fired internal electrode thin films; and

firing a multilayer body of the green sheets and the pre-fired internal electrode thin films;

wherein a content of the dielectric component in the pre-fired internal electrode thin film is larger than 0 wt % but not larger than 3 wt % with respect to the entire pre-fired internal electrode thin film.

Note that in the second aspect of the present invention, the dielectric thin film in the pre-fired internal electrode thin film is not particularly limited and BaTiO₃, MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ and SrTiO₃, etc. may be mentioned.

In the present invention, a pre-fired internal electrode thin film including a dielectric component together with a conductive component is formed as a pre-fired internal electrode thin film for composing internal electrode layers after firing. Here, the dielectric component is included as a common material. Therefore, spheroidizing in internal electrode layers caused by a difference of sintering temperatures between the dielectric material and the conductive material and breaking of electrodes, which have been notable disadvantages when the fired internal electrode layers are made thinner, can be effectively prevented and a decline of the capacitance can be effectively suppressed.

In the present invention, the conductive component to be included in the pre-fired internal electrode thin film is not particularly limited as far as it is composed of a material having conductivity and, for example, metal materials, etc. may be mentioned. Also, the dielectric component is not particularly limited and dielectric materials and other variety of inorganic materials may be used.

Both of the conductive component and dielectric component to be included in the internal electrode thin film form an internal electrode layer after firing, but a part of the dielectric component may form a dielectric layer after firing. Note that the pre-fired internal electrode thin film may include other components than the conductive component and dielectric component.

Also, in the present invention, by setting a content of the dielectric component in the pre-fired internal electrode thin film to be larger than 0 mol % but not larger than 0.8 mol % with respect to the entire pre-fired internal electrode thin film, breaking of electrodes can be effectively prevented. Alternately, by setting a content of the dielectric component in the pre-fired internal electrode thin film to be larger than 0 wt % but not larger than 3 wt % with respect to the entire pre-fired internal electrode thin film, breaking of electrodes can be effectively prevented.

The pre-fired internal electrode thin film can be formed by a method of forming a film directly on a green sheet to be a dielectric layer after firing and a method for forming a film on a release layer including a dielectric material, etc.

In the production method of the present invention, it is preferable to use a transfer method of forming the pre-fired internal electrode thin film on the release layer, then, forming an adhesive layer on the pre-fired internal electrode thin film, and bonding the pre-fired internal electrode thin film and a green sheet via the adhesive layer.

In the present invention, preferably, a thickness of the pre-fired internal electronic thin film is 0.1 to 1.0 μm, and more preferably 0.1 to 0.5. By setting a thickness of the pre-fired internal electrode thin film to be in the above ranges, the fired internal electrode layer can be thinner.

In the present invention, the pre-fired internal electrode thin film is preferably formed to be in a predetermined pattern by a thin film formation method. Preferably, the thin film formation method is, for example, the sputtering method, vapor deposition method or composite plating method. The sputtering method is particularly preferable.

By forming a pre-fired internal electrode thin film comprising the conductive component and dielectric component by a thin film formation method, particularly by the sputtering method, the dielectric component can be uniformly distributed in the pre-fired internal electrode thin film. Particularly, in the present invention, preferably, the dielectric component can be uniformly distributed at a nano-order level. Accordingly, even when a content of the dielectric component in the pre-fired internal electrode thin film is in a relatively small amount as above, the effect of adding the dielectric component can be sufficiently brought out, and breaking of electrodes caused by spheroidizing of the conductive material, such as a metal material, can be effectively prevented.

In the present invention, preferably, the pre-fired internal electrode thin film is formed by performing sputtering of a metal material and an inorganic material for composing the conductive component and the dielectric component at a time.

In the present invention, “performing sputtering at a time” means that sputtering is performed by a method that the conductive component and dielectric component are uniformly distributed in the pre-fired internal electrode thin film to be formed by the sputtering. As a method of “performing sputtering at a time”, for example, a method of alternately sputtering a conductive target including a metal material and a dielectric target including an inorganic material, such as a dielectric material, alternately at predetermined time intervals (for example, 1 to 30 seconds) may be mentioned. Alternately, a method of sputtering by using a composite target including the conductive component and the dielectric component may be also preferably used.

Note that the inorganic material is not particularly limited and a variety of dielectric materials and variety of inorganic oxides, etc. may be mentioned. As inorganic oxides, for example, BaTiO₃, MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ and SrTiO₃, etc. may be mentioned, and they may be also included as additive subcomponents in the pre-fired internal electrode thin film and the green sheet.

In the present invention, when performing sputtering as above, an inert gas is preferably used as an introduction gas. The inert gas is not particularly limited, but an Ar gas is preferably used. Also, a gas introduction pressure of the inert gas is preferably 0.01 to 2 Pa.

In the present invention, preferably, a dielectric component included in the pre-fired internal electrode thin film and the green sheet include dielectric having substantially the same composition. Due to this, adhesiveness of the pre-fired internal electrode thin film and green sheet can be furthermore improved and the effects of the present invention are enhanced. Note that, in the present invention, the dielectric to be included in the dielectric thin film and that in the green sheet are not always required to have the completely same composition and it is sufficient if the compositions are substantially the same. Also, the pre-fired internal electrode thin film and/or the green sheet may be respectively added with different subcomponents in accordance with need.

In the present invention, an average particle diameter of the dielectric component included in the pre-fired internal electrode thin film is preferably 1 to 10 nm. An average particle diameter of the dielectric component can be measured by cutting the pre-fired internal electrode thin film 12a and observing the cut surface by a TEM.

As a dielectric component included in the pre-fired internal electrode thin film and the dielectric to be included in the green sheet, for example, calcium titanate, strontium titanate and barium titanate, etc. may be mentioned. Among them, barium titanate is preferably used.

In the present invention, preferably, the conductive component included in the pre-fired internal electrode thin film includes nickel and/or a nickel alloy as its main component. As the nickel alloy, an alloy of at least one kind of element selected from ruthenium (Ru), rhodium (Rh), rhenium (Re) and platinum (Pt) with nickel is preferable, and a nickel content in the alloys is preferably 87 mol % or larger.

In the present invention, preferably, the multilayer body is fired in an atmosphere having an oxygen partial pressure of 10⁻² to 10⁻² Pa at a temperature of 1000° C. to 1300° C. According to the present invention, spheroidizing in the internal electrode layers and breaking of electrodes, which become notable disadvantages when firing at a higher temperature than a sintering temperature of the metal material, can be effectively prevented, so that firing at the above temperature becomes possible.

Preferably, after firing the multilayer body, annealing is performed in an atmosphere having an oxygen partial pressure of 10⁻² to 100 Pa at a temperature of 1200° C. or lower. By performing annealing under a specific condition after the firing, re-oxidization of the dielectric layers is attained, the dielectric layers are prevented from becoming semiconductor, and high insulation resistance can be obtained.

An electronic device according to the present invention is produced by any one of the methods explained above.

The electronic device is not particularly limited and a multilayer ceramic capacitor, piezoelectric device, chip inductor, chip varistor, chip thermistor, chip resistor, and other surface mounted (SMD) chip type electronic devices may be mentioned.

According to the present invention, it is possible to suppress grain growth of conductive particles in the firing step, effectively preventing spheroidizing of fired internal electrode layers and breaking of electrodes, and effectively suppressing a decline of capacitance.

### BRIEF DESCRIPTION OF DRAWINGS

These and other objects and features of the present invention will become clearer from the following description of the preferred embodiments given with reference to the attached drawings, in which:

FIG. 1 is a schematic sectional view of a multilayer ceramic capacitor according to an embodiment of the present invention;

FIG. 2 is a sectional view of a key part of a pre-fired internal electrode thin film according to a production method of the present invention;

FIG. 3A is a sectional view of a key part showing a method of forming the pre-fired internal electrode thin film of the present invention;

FIG. 3B is a sectional view of a key part showing a method of forming the pre-fired internal electrode thin film of the present invention;

FIG. 3C is a sectional view of a key part showing a method of forming the pre-fired internal electrode thin film of the present invention;

FIG. 4A is a schematic view from the side showing a sputtering method according to an embodiment of the present invention;

FIG. 4B is a schematic view from the above showing a sputtering method according to an embodiment of the present invention;

FIG. 5 is a sectional view of a key part of a sputtering target according to an embodiment of the present invention

FIG. 6A is a sectional view of a key part showing a method of transferring the pre-fired internal electrode thin film;

FIG. 6B is a sectional view of a key part showing a method of transferring the pre-fired internal electrode thin film;

FIG. 6C is a sectional view of a key part showing a method of transferring the pre-fired internal electrode thin film;

FIG. 7A is a sectional view of a key part showing a method of transferring the pre-fired internal electrode thin film;

FIG. 7B is a sectional view of a key part showing a method of transferring the pre-fired internal electrode thin film;

FIG. 7C is a sectional view of a key part showing a method of transferring the pre-fired internal electrode thin film;

FIG. 8 is a sectional view of a key part of a multilayer body sample according to an example of the present invention;

FIG. 9A is a SEM picture of an internal electrode layer after firing according to an example of the present invention; and

FIG. 9B is a SEM picture of an internal electrode layer after firing according to a comparative example of the present invention.

### DESCRIPTION OF THE PREFERRED EMBODIMENT

Below, the present invention will be explained based on embodiments shown in drawings.

First, as one embodiment of electronic devices produced by the method of the present invention, an overall configuration of a multilayer ceramic capacitor will be explained.

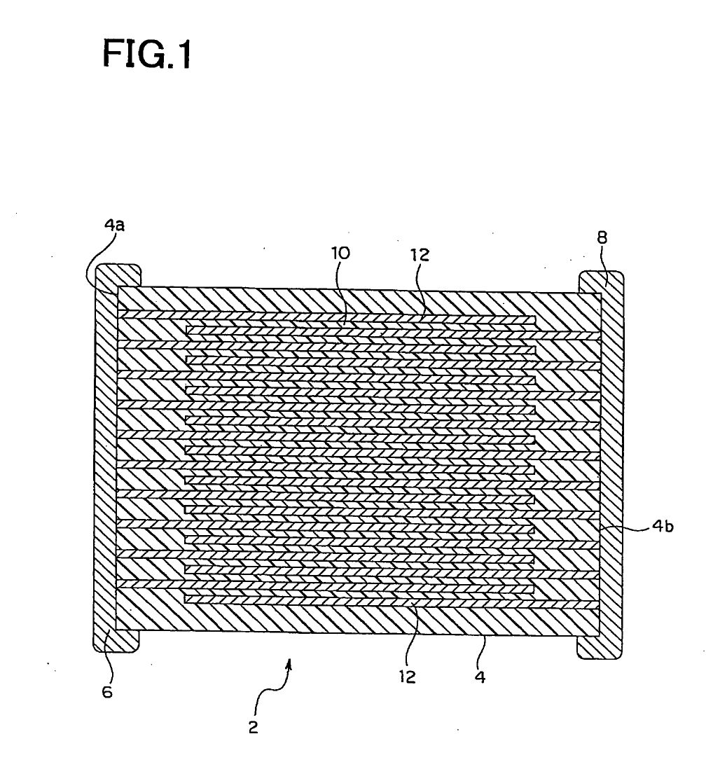

AS shown in FIG. 1, a multilayer ceramic capacitor 2 according to the present embodiment comprises a capacitor element body 4, a first terminal electrode 6 and a second terminal electrode 8. The capacitor element body 4 comprises dielectric layers 10 and internal electrode layers 12, and the internal electrode layers 12 are alternately stacked between the dielectric layers 10. The alternately stacked internal electrode layers 12 on one side are electrically connected to inside of the first terminal electrode 6 formed outside of a first end portion 4a of the capacitor element body 4. Also, the alternately stacked internal electrode layers 12 on the other side are electrically connected to inside of the second terminal electrode 8 formed outside of a second end portion 4b of the capacitor element body 4.

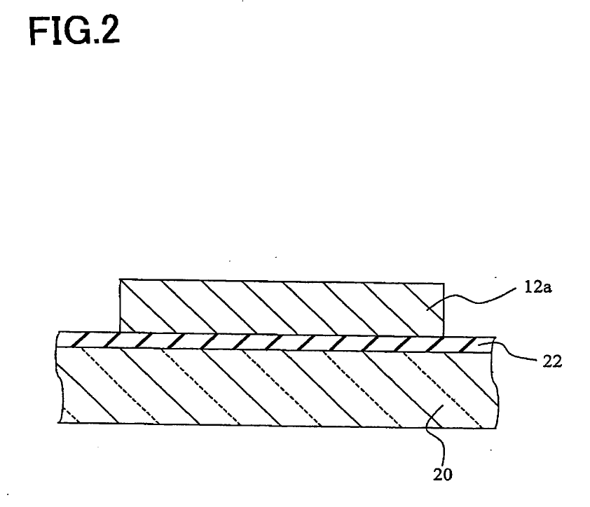

In the present embodiment, the internal electrode layer 12 is formed by firing a pre-fired internal electrode thin film 12a including a conductive component and a dielectric component shown in FIG. 2 as will be explained later on.

A material of the dielectric layers 10 is not particularly limited and it may be composed of dielectric materials, such as calcium titanate, strontium titanate and barium titanate. Among them, barium titanate is preferably used. Furthermore, the dielectric layers 10 may be added with a variety of subcomponents in accordance with need. A thickness of each dielectric layer 10 is not particularly limited but is generally several μm to hundreds of μm. Particularly in this embodiment, it is made as thin as preferably 5 μm or thinner, and more preferably 3 μm or thinner.

Also, a material of the terminal electrodes 6 and 8 is not particularly limited and copper, copper alloys, nickel and nickel alloys, etc. are normally used. Silver and an alloy of silver and palladium may be also used. A thickness of the terminal electrodes 6 and 8 is not particularly limited and is normally 10 to 50 μm or so.

A shape and size of the multilayer ceramic capacitor 2 may be suitably determined in accordance with the use object. When the multilayer ceramic capacitor 2 is a rectangular parallelepiped shape, it is normally a length (0.6 to 5.6 mm, preferably 0.6 to 3.2 mm)×width (0.3 to 5.0 mm, preferably 0.3 to 1.6 mm)×thickness (0.1 to 1.9 mm, preferably 0.3 to 1.6 mm) or so.

Next, an example of a production method of the multilayer ceramic capacitor 2 according to the present embodiment will be explained.

First, dielectric paste is prepared for producing a ceramic green sheet for composing the dielectric layers 10 shown in FIG. 1 after firing.

The dielectric paste is normally composed of organic solvent based paste obtained by kneading a dielectric material and an organic vehicle or water based paste.

The dielectric material may be suitably selected from composite oxides and a variety of compounds, which become oxides by firing, for example, carbonates, nitrites, hydroxides and organic metal compounds, etc. and mixed for use. The dielectric material is normally used as a powder having an average particle diameter of 0.1 to 3.0 μm or so. Note that, to form an extremely thin green sheet, it is preferable to use a finer powder than a thickness of the green sheet.

An organic vehicle is obtained by dissolving a binder in an organic solvent. The binder to be used for the organic vehicle is not particularly limited and may be suitably selected from a variety of normal binders, such as ethyl cellulose, polyvinyl butyral and an acrylic resin. Preferably, polyvinyl butyral or other butyral based resin is used.

Also, the organic solvent to be used for the organic vehicle is not particularly limited and an organic solvent, such as terpineol, butyl carbitol, acetone and toluene, is used. A vehicle in a water based paste is obtained by dissolving a water-soluble binder in water. The water-soluble binder is not particularly limited and polyvinyl alcohol, methyl cellulose, hydroxyl ethyl cellulose, water-soluble acrylic resin and emulsion, etc. may be used. A content of each component in the dielectric paste is not particularly limited and may be a normal content, for example, about 1 to 5 wt % of a binder and about 10 to 50 wt % of a solvent (or water).

The dielectric paste may contain additives selected from a variety of dispersants, plasticizers, dielectrics, glass frits and insulators, etc. in accordance with need. Note that a total content of them is preferably 10 wt % or smaller. When using a butyral based resin as the binder resin. It is preferable that a content of a plasticizer is 25 to 100 parts by weight with respect to 100 parts by weight of the binder resin. When the plasticizer is too small, the green sheet tends to become rattle, while when too large, the plasticizer exudes and the handleability becomes poor.

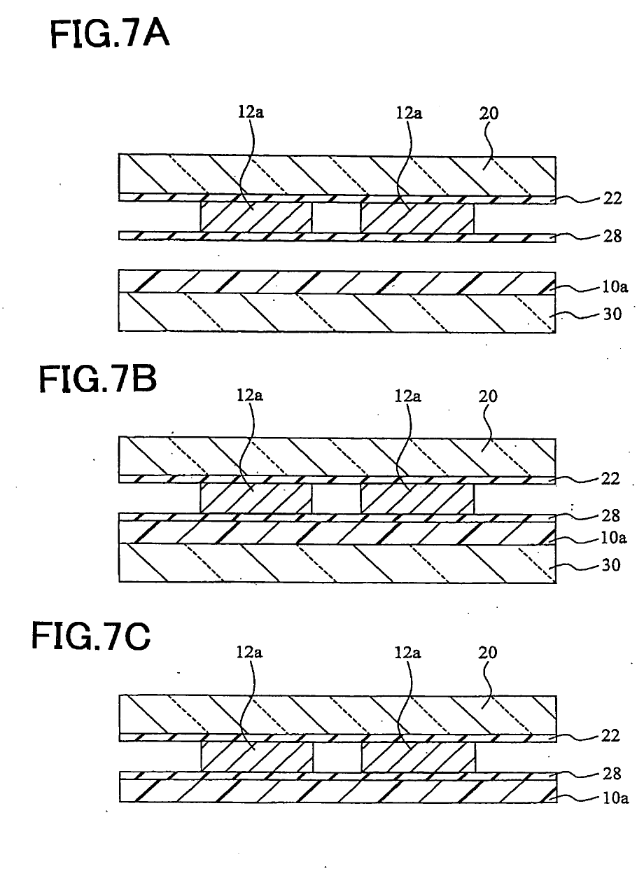

Next, by using the dielectric paste, a green sheet 10a is formed to be a thickness of preferably 0.5 to 30 μm and more preferably 0.5 to 10 μm or so on a carrier sheet 30 as a second support sheet as shown in FIG. 7A by the doctor blade method, etc. A temperature of drying the green sheet 10a is preferably 50 to 100° C. and the drying time is preferably 1 to 5 minutes.

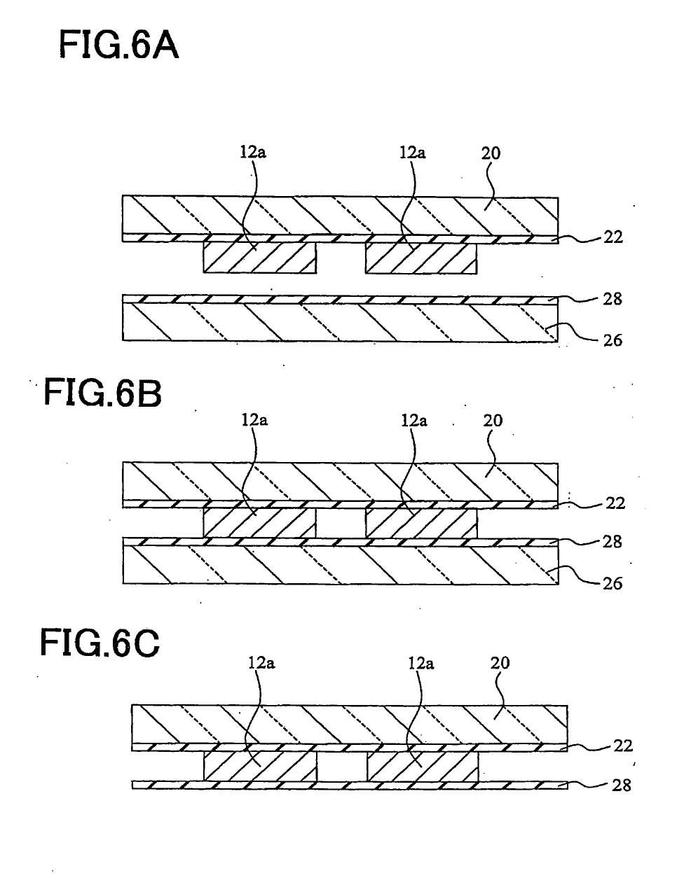

Next, as shown in FIG. 6A, a carrier sheet 20 as a first support sheet is prepared separately from the carrier sheet 30, and a release layer 22 is formed thereon. Then, on a surface of the release layer 22, a pre-fired internal electrode thin film 12a for composing an internal electrode layer 12 after firing is formed in a predetermined pattern.

For example, a PET film, etc. is used as the carrier sheets 20 and 30 and those coated with silicon, etc. are preferable to improve the releasing capability. Thicknesses of the carrier sheets 20 and 30 are not particularly limited, but 5 to 100 μm is preferable. The thicknesses of the carrier sheets 20 and 30 may be same or different.

The release layer 22 includes the same dielectric particles as the dielectric composing the green sheet 10a shown in FIG. 7A. Also, the release layer 22 includes a binder, a plasticizer and a releasing agent as an optional component in addition to the dielectric particles. A particle diameter of the dielectric particles may be the same as a particle diameter of the dielectric particles included in the green sheet, but it is preferably smaller. A method of forming the release layer 22 is not particularly limited but a method of applying by using a wire bar coater or a die coater is preferable because it has to be formed to be extremely thin.

The pre-fired internal electrode thin film 12a is formed on the release layer 22 as shown in FIG. 2 and includes a conductive component and a dielectric component.

The conductive component to be included in the internal electrode thin film 12a is not particularly limited as far as it is composed of a material having conductivity and metal materials, etc. may be mentioned. As such metal materials, for example when using a material having reduction resistance as a component of the dielectric layer 10, base metals may be used. As the base metals, metals including nickel as the main component or alloys of nickel with other metals are preferable. As nickel alloys, alloys of at least one kind of element selected from ruthenium (Ru), rhodium (Rh), rhenium (Re) and platinum (Pt) with nickel are preferable, and a nickel content in the alloys is preferably 87 mol % or larger. Note that the nickel alloys may include a variety of trace components, such as S, C and P, in an amount of about 0.1 wt % or smaller.

A dielectric component to be included in the internal electrode thin film 12a is not particularly limited and a variety of inorganic materials, such as a dielectric material, may be used. But it is preferable to include a dielectric material having substantially the same composition as that of the dielectric material included in the release layer 22 and the green sheet 10a. As a result, adhesiveness of contact surfaces formed between the internal electrode thin film 12a, the release layer 22 and the green sheet 10a can be furthermore improved.

A content of the dielectric component in the internal electrode thin film 12a is set to be larger than 0 mol % but not larger than 0.8 mol % with respect to the entire internal electrode thin film. Alternately, the content of the dielectric component in the internal electrode thin film 12a is set to be larger than 0 wt % but not larger than 3 wt % with respect to the entire internal electrode thin film. In the present embodiment, while it will be explained later on, the internal electrode thin film 12a is formed by a thin film formation method, such as the sputtering method, so that the dielectric component can be uniformly dispersed at a nano-order level. Accordingly, even when a content of the dielectric component is in a relatively small amount, the effect of adding the dielectric component can be efficiently brought out, and breaking of electrodes caused by spheroidizing of the conductive material, such as a metal material, can be effectively prevented.

A thickness of the pre-fixed internal electrode thin film 12a is preferably 0.1 to 1.0 μm, and more preferably 0.1 to 0.5 μm. By setting the thickness of the internal electrode thin film 12a to be in the above ranges, the fired internal electrode layer can become thinner.

As a method of forming the internal electrode thin film 12a including a conductive component and a dielectric component, the plating method, vapor deposition method, sputtering method and other thin film formation methods may be mentioned. In the present embodiment, it is formed by the sputtering method.

When forming the pre-fired internal electrode thin film 12a by the sputtering method, it is performed, for example, as below.

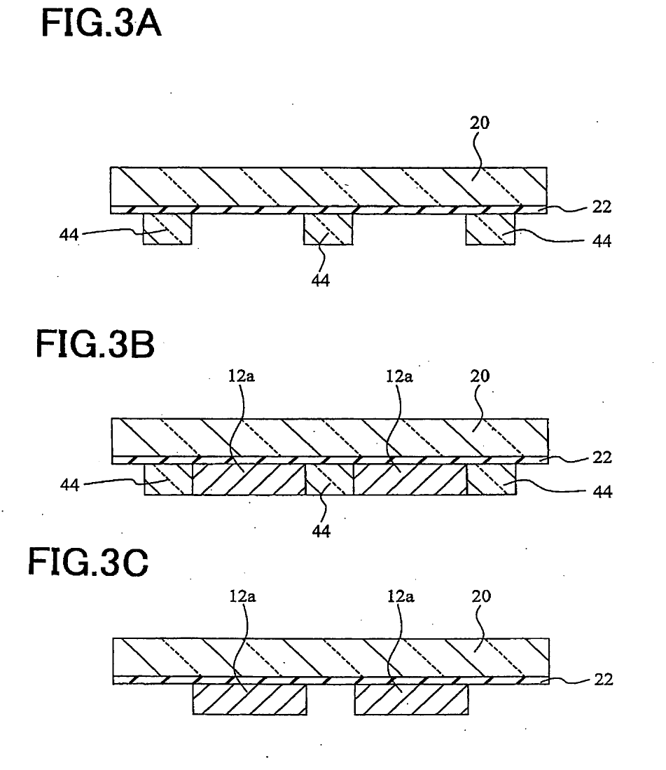

First, as shown in FIG. 3A, on a surface of the release layer 22 on the carrier sheet 20, a metal mask 44 having a predetermined pattern is formed as a shield mask. Next, as shown in FIG. 3B, an internal electrode thin film 12a is formed on the release layer 22.

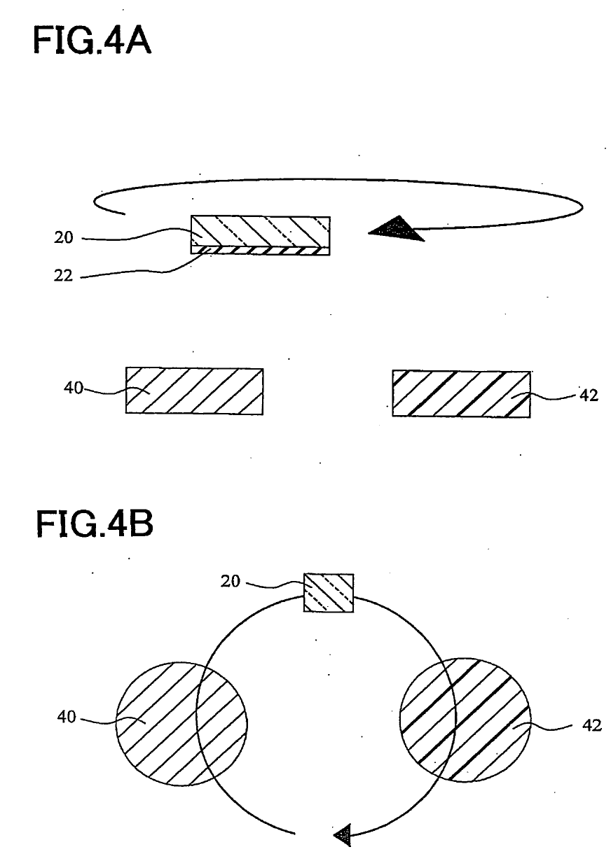

In the present embodiment, the internal electrode thin film 12a is formed by using a conductive target 40 including a conductive component and a dielectric target 42 including a dielectric component as shown in FIG. 4A and FIG. 4B and performing sputtering alternately by both of the targets. Namely, in the present embodiment, as shown in FIG. 4A and FIG. 4B, the carrier sheet 20 formed with the release layer 22 and the metal mask 44 (not shown) rotates above the conductive target and the dielectric target 42 so as to form a conductive component and dielectric component on the release layer 22 alternately at predetermined time intervals (for example, 1 to 30 seconds). By forming the conductive component and dielectric component alternately at intervals of several seconds, the dielectric component can be uniformly distributed in the internal electrode thin film 12a at a nano-order level, and aggregation of the dielectric component can be effectively prevented.

Namely, in the present embodiment, an average particle diameter of the dielectric component included in the pre-fired internal electrode thin film 12a can be preferably 1 to 10 nm and uniform dispersion can be attained. Note that the average particle diameter of the dielectric component can be measured by cutting the pre-fired internal electrode thin film 12a and observing the cut surface by a TEM.

The rotation rate is, for example, 0.5 to 15 rpm, and sputtering of the conductive target 40 and the dielectric target 42 is preferably performed at intervals of 1 to 30 seconds.

As the conductive target 40 to from the conductive component in the internal electrode thin film 12a, a conductive material may be used and, for example, metals including nickel as the main component or alloys of nickel with other metals, etc. may be used.

Also, as the dielectric target 42 for forming the dielectric component in the internal electrode thin film 12a, dielectric materials and other variety of inorganic materials may be used and, for example, composite oxides and a variety of compounds which become oxides by firing, etc. may be mentioned.

When performing sputtering, it is preferable to use an inert gas, particularly, an Ar gas as an introduction gas, and the gas introduction pressure is preferably 0.1 to 2 Pa. As other sputtering conditions, the ultimate vacuum is preferably 10⁻² Pa and lower preferably 10⁻³ Pa or lower, and the sputtering temperature is preferably 20 to 150° C. and more preferably 20 to 150° C.

Note that, in the present embodiment, a content ratio of the conductive component and the dielectric component in the internal electrode thin film 12a can be controlled, for example, by adjusting outputs of the conductive target 40 and the dielectric target 42. An output of the conductive target 40 is preferably 50 to 400 W and more preferably 100 to 300 W, and an output of the dielectric target 42 is preferably 10 to 100 W and more preferably 10 to 50 W. Also, preferably, a film forming rate of the conductive component is 5 to 20 nm/min., and a film forming rate of the dielectric component is 1 nm/min. or lower.

A thickness of the internal electrode thin film 12a can be controlled by adjusting the respective sputtering conditions and film forming time.

Next, by removing the metal mask 44, the internal electrode thin film 12a having a predetermined pattern as shown in FIG. 3C and including a conductive component and a dielectric component can be formed on a surface of the release layer 22.

Next, separately from the carrier sheets 20 and 30, as shown in FIG. 6A, an adhesive layer transfer sheet is prepared, wherein an adhesive layer 28 is formed on a surface of a carrier sheet 26 as the third support sheet. The carrier sheet 26 is the same sheet as the carrier sheets 20 and 30. A composition of the adhesive layer 28 is the same as that of the release layer 22 except for not including any mold releasing agents. Namely, the adhesive layer 28 includes a binder, plasticizer and mold releasing agent. The adhesive layer 28 may include the same dielectric particles as those in the dielectric composing the green sheet 10a, but when forming a thin adhesive layer having a thinner thickness than a particle diameter of the dielectric particles, it is more preferable not to include the dielectric particles.

Next, the adhesive layer is formed on a surface of the internal electrode thin film 12a shown in FIG. 6A by a transfer method. Namely, as shown in FIG. 6B, the adhesive layer 28 of the carrier sheet 26 is pressed against the surface of the internal electrode layer 12a, heat and pressure are applied thereto, then, the carrier sheet 26 is removed, consequently, the adhesive layer 28 is transferred to the surface of the internal electrode thin film 12a as shown in FIG. 6C.

A heating temperature at that time is preferably 40 to 100° C., and the pressure force is preferably 0.2 to 15 MPa. The pressure may be applied by a press or by a calendar roll, but it is preferable to use a pair of rolls.

After that, the internal electrode thin film 12a is bonded with the surface of the green sheet 10a formed on the surface of the carrier sheet 30 shown in FIG. 7A. For that purpose, as shown in FIG. 7B, the internal electrode thin film 12a on the carrier sheet 20 is pressed against the surface of the green sheet 10a together with the carrier sheet 20 via the adhesive layer 28, heat and pressure are applied so as to transfer the internal electrode thin film 12a to the surface of the green sheet 10a as shown in FIG. 7C. Note that since the carrier sheet 30 on the green sheet side is peeled off, when seeing from the green sheet 10a side, the green sheet 10a is transferred to the internal electrode thin film 12a via the adhesive layer 28.

The heat and pressure at the transfer may be applied by a press or by a calendar roll, but it is preferable to use a pair of rolls. The heating temperature and pressure are the same as those in transferring the adhesive layer 28.

From the steps as above shown in FIG. 6A to FIG. 7C, the pre-fired internal electrode thin film 12a including a conductive component and a dielectric component is formed on one green sheet 10a. By using the result, a multilayer body, wherein a large number of the internal electrode thin films 12a and the green sheets 10a are alternately stacked, is obtained.

Then, after finally pressuring the multilayer body, the carrier sheet 20 is peeled off. A pressure at the final pressuring is preferably 10 to 200 MPa. Also, the heating temperature is preferably 40 to 100° C. After that, the multilayer body is cut to be a predetermine size to form a green chip. Then, the green chip is subjected to binder removal processing and firing.

The binder removal processing is preferably performed in the air or in N₂ of a binder removal atmosphere when nickel as a base metal is used as the conductive component of the internal electrode layer as in the present invention. Also, as other binder removal conditions, the temperature raising rate is preferably 5 to 300° C./hour and more preferably 10 to 50° C./hour, the holding temperature is preferably 200 to 400° C. and more preferably 250 to 350° C., and the temperature holding time is preferably 0.5 to 20 hours and more preferably 1 to 10 hours.

Firing of the green chip is preferably performed in an atmosphere under an oxygen partial pressure of 10⁻¹⁰ to 10⁻² Pa and more preferably 10⁻¹⁰ to 10⁻⁵ Pa. When the oxygen partial pressure at the firing is too low, the conductive material in the internal electrode layer may result in abnormal sintering to be broken, while when too high, the internal electrode layer tends to be oxidized.

Firing of the green chip is performed at a low temperature of 1300° C. or lower, more preferably 1000 to 1300° C., and particularly preferably 1150 to 1250° C. When the firing temperature is too low, the green chip is not densified, while when too high, breaking of electrodes in the internal electrode layer is caused and the dielectric is reduced.

As other firing conditions, the temperature raising rate is preferably 50 to 500° C./hour and more preferably 200 to 300° C./hour, the temperature holding time is preferably 0.5 to 8 hours and more preferably 1 to 3 hours, and the cooling rate is preferably 50 to 500° C./hour and more preferably 200 to 300° C./hour. The firing atmosphere is preferably a reducing atmosphere, and a mixed gas of N₂ and H₂ in a wet state is preferably used as the atmosphere gas.

Next, annealing is performed on the fired capacitor chip body. Annealing is processing for re-oxidizing the dielectric layers, and an accelerated lifetime of insulation resistance (IR) can be remarkably elongated and reliability improves by that.

Annealing of the fired capacitor chip body is preferably performed under a higher oxygen partial pressure than that of the reducing atmosphere at the time of firing, specifically, the oxygen partial pressure of the atmosphere is preferably 10⁻² to 100 Pa, and more preferably 10⁻² to 10 Pa. When the oxygen partial pressure at annealing is too low, re-oxidizing of the dielectric layers 10 becomes difficult, while when too high, the internal electrode layers 12 tend to be oxidized.

In the present embodiment, the holding temperature or the highest temperature at annealing is preferably 1200° C. or lower, more preferably 900 to 1150° C., and particularly preferably 1000 to 1100° C. Also, in the present invention, the holding time of the temperature is preferably 0.5 to 4 hours and more preferably 1 to 3 hours. When the holding temperature or the highest temperature at annealing is lower than the above ranges, oxidization of the dielectric material becomes insufficient and the insulation resistance lifetime tends to become short, while when it is higher than the above ranges, it is liable that nickel in the internal electrode layers is oxidized and not only declining the capacity but it reacts with the dielectric base and the lifetime also becomes short. Note that the annealing may be composed only of the temperature raising step and the temperature lowering step. Namely, the temperature holding time may be zero. In that case, the holding temperature is the highest temperature.

As other annealing conditions, the cooling rate is preferably 50 to 500° C./hour and more preferably 100 to 300° C./hour. As the atmosphere gas at annealing, for example, a wet N₂ gas, etc. is preferably used.

Note that to wet the N₂ gas, for example, a wetter, etc. is used. In that case, the water temperature is preferably 0 to 75° C. or so.

The binder removal processing, firing and annealing may be performed continuously or separately. When performing continuously, the atmosphere is changed without cooling after the binder removal processing, continuously, the temperature is raised to the holding temperature at firing to perform firing. Next, it is cooled and the annealing is preferably performed by changing the atmosphere when the temperature reaches to the holding temperature of the annealing. On the other hand, when performing them separately, at the time of firing, after raising the temperature to the holding temperature of the binder removal processing in an atmosphere of a nitrogen gas or a wet nitrogen gas, the atmosphere is changed, and the temperature is preferably furthermore raised. After that, after cooling the temperature to the holding temperature of the annealing, it is preferable that the cooling continues by changing the atmosphere again to a N₂ gas or a wet N₂ gas. Also, in the annealing, after raising the temperature to the holding temperature under the N₂ gas atmosphere, the atmosphere may be changed, or the entire process of the annealing may be in a wet N₂ gas atmosphere.

End surface polishing, for example, by barrel polishing or sand blast, etc. is performed on the sintered body (element body 4) obtained as above, and the external electrode paste is burnt to form external electrodes 6 and 8. A firing condition of the external electrode paste is preferably, for example, at 600 to 800° C. in a wet mixed gas of N₂ and H₂ for 10 minutes to 1 hour or so. A pad layer is formed by plating, etc. on the surface of the external electrodes 6 and 8 if necessary. Note that the terminal electrode paste may be fabricated in the same way as the electrode paste explained above.

A multilayer ceramic capacitor of the present invention produced as above is mounted on a print substrate, etc. by soldering, etc. and used for a variety of electronic apparatuses, etc.

In the present embodiment, an internal electrode thin film 12a including a conductive component and a dielectric component, wherein a content of the dielectric component is larger than 0 mol % but not larger than 0.8 mol %, is formed as the pre-fired internal electrode thin film 12a for composing the internal electrode layer 12 after firing. Alternately, an internal electrode thin film 12a including a conductive component and a dielectric component, wherein a content of the dielectric component is larger than 0 wt % but not larger than 3 wt %, is formed as the pre-fired internal electrode thin film 12a for composing the internal electrode layer 12 after firing. Therefore, spheroidizing of the internal electrode layers and breaking of electrodes caused by a difference of sintering temperatures between the dielectric material and conductive material in the case of making the fired internal electrode layers 12 thinner, which have been notable disadvantages, are effectively prevented and a decline of the capacitance can be effectively suppressed.

Also, in the present embodiment, the internal electrode thin film 12a including a conductive component and a dielectric component is formed by the sputtering method, so that the dielectric component can be uniformly distributed in the internal electrode thin film 12a at a nano-order level. Accordingly, even when a content of the dielectric component in the internal electrode thin film 12a is in a relatively small amount as explained above, the effect of adding the dielectric component can be sufficiently brought out, and breaking of electrodes caused by spheroidizing of the conductive material, such as a metal material, can be effectively prevented.

An embodiment of the present invention was explained above, however, the present invention is not limited to the embodiment and a variety of modifications may be naturally made within the scope of the present invention.

For example, in the above embodiment, a multilayer ceramic capacitor was explained as an example of an electronic device according to the present invention, however, the electronic device according to the present invention is not limited to multilayer ceramic capacitors and the present invention can be applied to other electronic devices.

Also, in the above embodiment, the conductive target 40 and the dielectric target 42 as shown in FIG. 4A and FIG. 4B were used as sputtering targets at the time of forming the pre-fired internal electrode thin film 12a by the sputtering method, however, composite targets obtained by mixing and firing a conductive component and dielectric component may be also used. When using such composite targets, a rate of the conductive component and the dielectric component included in the internal electrode thin film 12a can be controlled by adjusting a mixing ratio of the conductive component and the dielectric component in the composite targets.

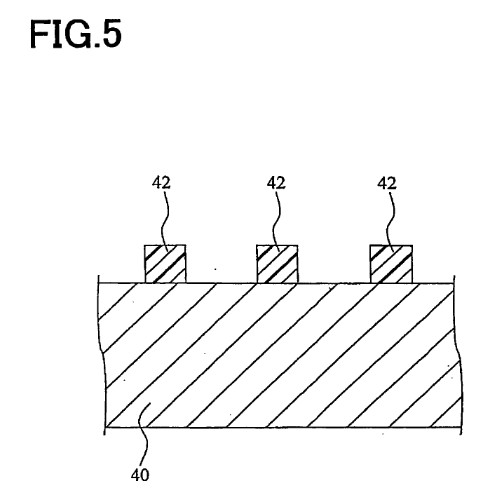

Alternately, as the sputtering targets, a target formed by mounting a plurality of dielectric targets processed to be in a pellet shape on a conductive target as shown in FIG. 5 may be also used. In that case, also, by adjusting a size or number of the pellet-shaped dielectric target to be mounted on the conductive target, the ratio of the conductive component and dielectric component to be included in the internal electrode thin film 12a can be controlled.

Also, before the step of forming the adhesive layer 28 on the surface of the pre-fired internal electrode thin film 12a, a blank pattern layer having substantially the same thickness as that of the internal electrode thin film 12a and composed of substantially the same material as the green sheet 10a may be formed on the surface of the release layer 22, on which the internal electrode thin film 12a is not formed.

Also, in the present invention, other thin film formation methods than the sputtering method may be used. As other thin film formation methods, the vapor deposition method and composite plating method, etc. may be mentioned.

### EXAMPLES

Below, the present invention will be explained based on furthermore detailed examples, but the present invention is not limited to these examples.

### Example 1

### Production of Respective Paste

First, a BaTiO₃ powder (BT-02 made by Sakai Chemical Industry Co., Ltd.), MgCO₃, MnCO₃, (Ba_{0.6}Ca_{0.4})SiO₃ and a powder selected from rare earths (Gd₂O₃, Tb₄O₇, Dy₂O₃, Ho₂O₃, Er₂O₃, Tm₂O₃, Yb₂O₃, Lu₂O₃ and Y₂O₃) were wet mixed by a ball mill for 16 hours and dried to obtain a dielectric material. An average particle diameter of these material powders was 0.1 to 1 μm. The (Ba_{0.6}Ca_{0.4})SiO₃ was produced by wet mixing BaCo₃, CaCO₃ and SiO₂ by a ball mill for 16 hours, drying, then, firing at 1150° C. in the air, and dry pulverizing the result by a ball mill for 100 hours.

To make the obtained dielectric material to be paste, an organic vehicle was added to the dielectric material and mixed by a ball mill, so that dielectric green sheet paste was obtained. The organic vehicle has a compounding ratio of polyvinyl butyral as a binder in an amount of 6 parts by weight, bis(2-ethylhexyl)phthalate (DOP) as a plasticizer in an amount of 3 parts by weight, ethyl acetate in an amount of 55 parts by weight, toluene in an amount of 10 parts by weight and paraffin as a releasing agent in an amount of 0.5 part by weight with respect to 100 parts by weight of the dielectric material.

Next, the dielectric green sheet paste was diluted two times in a weight ratio with ethanol/toluene (55/10) to obtain release layer paste.

Then, the same dielectric green sheet paste except for not including dielectric particles and releasing agent was diluted four times in a weight ratio with toluene to obtain adhesive layer paste.

Formation of Green Sheet 10a

First, the dielectric green sheet paste was applied to a PET film (second support sheet) by using a wire bar coater and, then, dried to form a green sheet having a thickness of 1.0 μm.

Formation of Pre-Fired Internal Electrode Thin Film 12a

The release layer paste is applied on another PET film (first support sheet) by using a wire bar coater and, then, dried to form a release layer having a thickness of 0.3 μm.

Next, on a surface of the release layer, the pre-fired internal electrode thin film 12a including a conductive component and a dielectric component as shown in FIG. 2 was formed by the sputtering method by using a metal mask 44 having a predetermined pattern for forming an internal electrode thin film 12a. A thickness of the internal electrode thin film 12a was 0.4 μm, and a content ratio of the conductive component and dielectric component to be included in the internal electrode thin film 12a was as those shown in Table 1, respectively. Note that the content ratio of the dielectric component and the dielectric component was adjusted by changing an output of the dielectric target while keeping an output of the conductive target constant.

In this example, sputtering was performed by the method shown in FIG. 4A and FIG. 4B by first preparing a conductive target for forming a conductive component and a dielectric target for forming a dielectric component. Ni was used as the conductive target, and BaTiO₃ was used as the dielectric target. Sputtering targets obtained by cutting into a shape having a diameter of about 4 inches and a thickness of 3 mm were used as the Ni and BaTiO₃ targets.

As other sputtering conditions, the ultimate vacuum was 10⁻³ or lower, an Ar gas introduction pressure was 0.5 Pa, and the temperature was the room temperature (20° C.). Also, outputs at sputtering was 200 W at the Ni target and 10 to 100 W at the BaTiO₃ target.

Note that, in this example, when forming the internal electrode thin film 12a on respective samples, a film was also formed on a glass substrate by sputtering at the same time. Then, the glass substrate having a thin film formed thereon was broken and the broken section surface was observed by SEM so as to measure a thickness of the internal electrode thin film 12a formed by sputtering.

Formation of Adhesive Layer

The adhesive layer paste explained above was applied to another PET film (third support sheet) by using a wire bar coater and, then, dried to form an adhesive layer having a thickness of 0.2 μm. Note that, in this example, a PET film having surfaces subjected to release processing by a silicon based resin was used for all of the PET films (the first support sheet, second support sheet and third support sheet).

Formation of Final Multilayer Body (Pre-Fired Element Body)

First, the adhesive layer 28 was transferred to a surface of the internal electrode thin film 12a by the method shown in FIG. 6. At transferring, a pair of rolls were used, the pressure was 1 MPa and the temperature was 80° C.

Next, the internal electrode thin film 12a was bonded (transferred) to a surface of the green sheet 10a via the adhesive layer 28 by the method shown in FIG. 7. At transferring, a pair of rolls were used, the pressure was 1 MPa and the temperature was 80° C.

Next, the internal electrode thin films 12a and green sheets 10a were stacked successively and, finally, a final multilayer body was obtained, wherein 21 layers of internal electrode thin films 12a were stacked. A stacking condition was a pressure of 50 MPa and a temperature of 120° C.

Production of Sintered Body

Next, the final multilayer body was cut to be a predetermined size and subjected to binder removal processing, firing and annealing (thermal treatment), so that a sintered body in a chip shape was produced.

The binder removal processing was performed as below.

Temperature raising rate: 15 to 50° C./hour

Holding temperature: 400° C.

Holding time: 2 hours

Cooling rate: 300° C./hour

Atmosphere gas: wet N₂ gas

The firing was performed as below.

Temperature raising rate: 200 to 300° C./hour

Holding temperature: 1200° C.

Holding time: 2 hours

Cooling rate: 300° C./hour

Atmosphere gas: wet mixed gas of N₂+H₂

Oxygen partial pressure: 10⁻⁷ Pa

The annealing (re-oxidization) was performed as below.

Temperature raising rate: 200 to 300° C./hour

Holding temperature: 1050° C.

Temperature holding time: 2 hours

Cooling rate: 300° C./hour

Atmosphere gas: wet N₂ gas

Oxygen partial pressure: 10⁻¹ Pa

Note that a wetter with a water temperature of 0 to 75° C. was used to wet the atmosphere gases at the time of binder removal, firing and annealing.

Next, end surfaces of the chip-shaped sintered body was polished by sand blast, then, an external electrode paste was transferred to the end surfaces and fired at 800° C. for 10 minutes in a wet N₂+H₂ atmosphere to form external electrodes, so that a multilayer capacitor sample having the configuration shown in FIG. 1 was obtained.

A size of each of the thus obtained samples was 3.2 mm×1.6 mm×0.6 mm, the number of dielectric layers sandwiched by the internal electrode layers was 21, a thickness thereof was 1 μm, and a thickness of the internal electrode layer was 0.5 μm. Electric characteristics (capacitance C and dielectric loss tan δ) were evaluated on each sample. The results are shown in Table 1. The electric characteristics (capacitance C and dielectric loss tan δ) were evaluated as below.

The capacitance C (unit: μF) was measured by a digital LCR meter (4274A made by YHP) at a reference temperature of 25° C. under conditions that a frequency was 1 kHz and an input signal level (measurement voltage) was 1 Vrms. Capacitance C of 0.9 μF or higher was evaluated good.

The dielectric loss tan δ was measured by using a digital LCR meter (4274A made by YHP) at a reference temperature of 25° C. under conditions that a frequency was 1 kHz and an input signal level (measurement voltage) was 1 Vrms. Dielectric loss tan δ of less than 0.1 was evaluated good.

Note that the characteristic values were obtained from an average value of values measured by using the number of samples n=10. In Table 1, “o” in the evaluation standard column indicates that preferable results were exhibited in all of the above characteristics, and “x” indicates that one or more results were not preferable among those.

TABLE 1

| | | Pre-Fired Internal Electrode Thin Film 12a | | | | | |
|---|---|---|---|---|---|---|---|
| | | | Content Ratio | Content Ratio | | | |
| Sample | | Thickness | of Nickel | of BaTiO₃ | Capacitance | | |
| No. | | [μm] | [mol %] | [mol %] | [μF] | tan δ | Evaluation |
| 1 | Comparative | 0.4 | 100 | 0.0 | 0.83 | 0.01 | X |
| | Example | | | | | | |
| 2 | Example | 0.4 | 99.82 | 0.18 | 0.98 | 0.01 | ◯ |
| 3 | Example | 0.4 | 99.65 | 0.35 | 1.1 | 0.01 | ◯ |
| 4 | Example | 0.4 | 99.20 | 0.80 | 0.95 | 0.02 | ◯ |
| 5 | Comparative | 0.4 | 98.67 | 1.33 | 0.72 | 0.02 | X |
| | Example | | | | | | |

Table 1 shows a thickness of a pre-fired internal electrode thin film 12a formed for each sample, a content ratio of nickel and BaTiO₃, capacitance, dielectric loss tan δ and evaluation on each sample.

As shown in Table 1, all of the samples 2 to 4 in the example, wherein the pre-fired internal electrode thin film 12a included nickel as a conductive component and BaTiO₃ as a dielectric component and a content ratio of BaTiO₃ was respectively 0.18, 0.35 and 0.80 mol %, exhibited preferable results that the capacitance exceeded 0.9 μF and the dielectric loss tan δ was less than 0.1.

On the other hand, in the sample 1 as a comparative example, wherein BaTiO₃ as a dielectric component was not included in the internal electrode thin film 12a, spheroidizing arose in the internal electrode layers, breaking of electrodes arose and the capacitance became as low as 0.83 μF. Also, in a sample as a comparative example, wherein a content ratio of BaTiO₃ in the internal electrode thin film 12a was 1.33 mol %, breaking of the internal electrode layers arose and the capacitance became low as 0.72 μF.

It was confirmed that as a result that a conductive component and a dielectric component were included in the pre-fired internal electrode thin film and a content of the dielectric component in the internal electrode thin film was larger than 0 mol % but not larger than 0.8 mol % with respect to the entire internal electrode thin film, spheroidizing in the internal electrode layers and breaking of electrodes could be prevented effectively and a decline of the capacitance could be suppressed even when the fired internal electrode layers were made thinner.

### Example 2

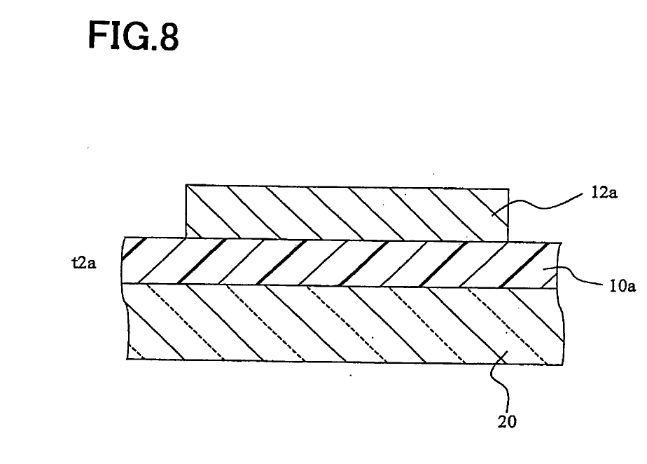

The dielectric green sheet paste produced in the example 1 was applied to the PET film (carrier sheet) by using a wire bar coater and, then, dried to obtain a green sheet 10a. A pre-fired internal electrode thin film 12a was formed on the green sheet 10a in the same way as in the example 1 and a multilayer body as shown in FIG. 8 was produced. Next, the PET film was removed from the multilayer body to produce a pre-fired sample composed of the green sheet 10a and the internal electrode thin film 12a. The pre-fired sample was subjected to binder removal, firing and annealing in the same way as in the example 1, so that a sample for surface observation after firing composed of the dielectric layers 10 and the internal electrode layers 12 was produced.

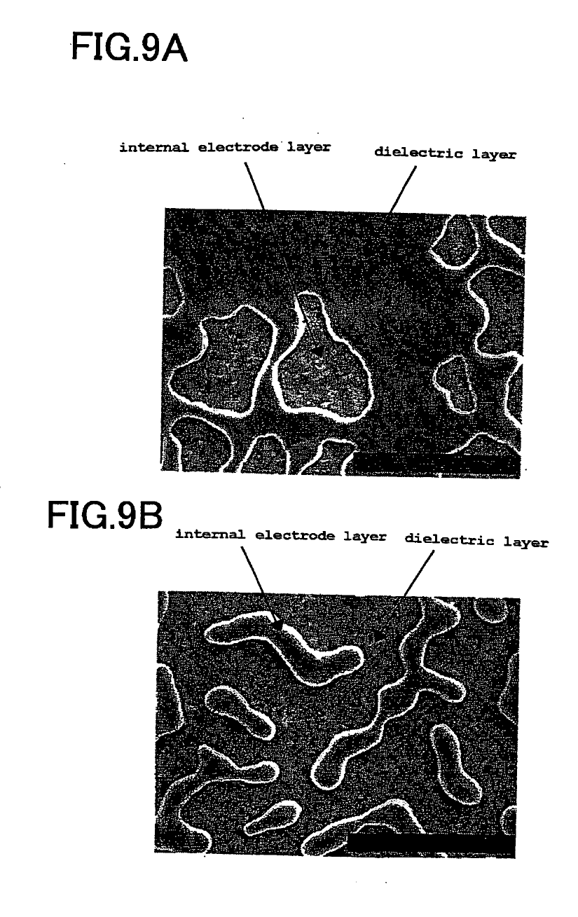

Next, SEM observation was made on the obtained surface observation sample from the vertical direction with respect to the surface formed with the internal electrode layer 12, and the fired internal electrode layer was observed and evaluated. Obtained SEM pictures are shown in FIG. 9A and FIG. 9B. FIG. 9A corresponds to the sample 3 in the example 1, and FIG. 9B corresponds to the sample 1 in the example 1. Namely, FIG. 9A and FIG. 9B are SEM pictures of samples, wherein internal electrode thin film was formed under the same condition as that in the respective capacitor samples in the example 1.

FIG. 9A is a SEM picture of a sample, wherein the pre-fired internal electrode thin film 12a included nickel as a conductive component and BaTiO₃ as a dielectric component and a content ratio of BaTiO₃ was 0.35 mol %, and as is obvious from the picture, breaking of the internal electrode layers (white parts in the SEM picture) was not observed and a preferable result was obtained.

On the other hand, from FIG. 9B, the sample, wherein BaTiO₃ as a dielectric component was not included in the internal electrode thin film 12a, exhibited results that spheroidizing of nickel arose and breaking of electrodes became notable. Particularly, by comparing FIG. 9A and FIG. 9B, it can be confirmed that spheroidizing of nickel can be suppressed and breaking of internal electrodes can be effectively prevented as a result that the internal electrode thin film 12a includes a dielectric component in a range of the present invention.

### Example 3

Other than using Yb₂O₃ instead of BaTiO₃ as a dielectric target when forming the pre-fired internal electrode thin film 12a, samples were obtained in the same way as in the example 1. An evaluation of electric characteristics (capacitance C and dielectric loss tan δ) was made on each sample. The results are shown in Table 2. The electric characteristics (capacitance C and dielectric loss tan δ) were evaluated in the same way as in the example 1.

TABLE 2

| | | Pre-Fired Internal Electrode Thin Film 12a | | | | | |
|---|---|---|---|---|---|---|---|
| | | | Content Ratio | Content Ratio | | | |
| Sample | | Thickness | of Nickel | of BaTiO₃ | Capacitance | | |
| No. | | [μm] | [mol %] | [mol %] | [μF] | tan δ | Evaluation |
| 6 | Comparative | 0.4 | 100.00 | 0.0 | 0.83 | 0.01 | X |
| | Example | | | | | | |
| 7 | Example | 0.4 | 99.30 | 0.70 | 0.97 | 0.02 | ◯ |
| 8 | Example | 0.4 | 98.10 | 1.90 | 0.95 | 0.02 | ◯ |
| 9 | Example | 0.4 | 97.00 | 3.00 | 0.92 | 0.02 | ◯ |
| 10 | Comparative | 0.4 | 94.86 | 5.14 | 0.74 | 0.02 | X |
| | Example | | | | | | |

Table 2 shows a thickness of a pre-fired internal electrode thin film 12a formed for each sample, a content ratio of nickel and Yb₂O₃, capacitance, dielectric loss tan δ and evaluation on each sample.

As shown in Table 2, all of the samples 2 to 4 in the example, wherein the pre-fired internal electrode thin film 12a included nickel as a conductive component and Yb₂O₃ as a dielectric component and a content ratio of Yb₂O₃ was respectively 0.7, 1.9 and 3 wt %, exhibited preferable results that the capacitance exceeded 0.9 μF and the dielectric loss tan δ became less than 0.1.

On the other hand, in the sample 1 as a comparative example, wherein Yb₂O₃ as a dielectric component was not included in the internal electrode thin film 12a, spheroidizing arose in the internal electrode layers, breaking of electrodes arose and the capacitance became as low as 0.83 μF. Also, in the sample as a comparative example, wherein a content ratio of Yb₂O₃ in the internal electrode thin film 12a was 5.14 wt %, breaking of electrodes arose in the internal electrode layers and the capacitance became low as 0.74 μF.

It was confirmed that as a result that a conductive component and a dielectric component were included in the pre-fired internal electrode thin film and a content of the dielectric component in the internal electrode thin film is larger than 0 wt % but not larger than 3 wt % with respect to the entire internal electrode thin film, spheroidizing in the internal electrode layers and breaking of electrodes were able to be prevented effectively and a decline of the capacitance could be suppressed even when the fired internal electrode layers were made thinner. Note that it was confirmed that it is preferably larger than 0 wt % but not larger than 3 wt % in the case of Yb₂O₃ and, from the results of the example 4 below, it is considered that the same results can be obtained in the case of MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ or SrTiO₃.

### Example 4

Other than using MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ or SrTiO₃ instead of BaTiO₃ as a dielectric target when forming the pre-fired internal electrode thin film 12a, samples were obtained in the same way as in the example 1. Evaluation of electric characteristics (capacitance C and dielectric loss tan δ) was made on each sample in the same way as in the example 1. The results are shown in Table 3. Evaluation of the electric characteristics (capacitance C and dielectric loss tan δ) was made in the same way as in the example 1.

TABLE 3

| | | Pre-Fired Internal Electrode Thin Film 12a | | | | | | |
|---|---|---|---|---|---|---|---|---|
| | | | Content | | Content | | | |
| Sample | | Thickness | Ratio of | | Ratio | Capacitance | | |
| No. | | [μm] | Nickel | Added Oxide | [wt %] | [μF] | tan δ | Evaluation |
| 11 | Example | 0.4 | 99.5 | MgO | 0.5 | 0.95 | 0.02 | ◯ |
| 12 | Example | 0.4 | 99.5 | Al2O3 | 0.5 | 0.97 | 0.02 | ◯ |
| 13 | Example | 0.4 | 99.4 | SiO2 | 0.6 | 0.95 | 0.04 | ◯ |
| 14 | Example | 0.4 | 99.4 | CaO | 0.6 | 0.95 | 0.03 | ◯ |
| 15 | Example | 0.4 | 99.4 | TiO2 | 0.6 | 0.97 | 0.02 | ◯ |
| 16 | Example | 0.4 | 99.3 | V2O3 | 0.7 | 0.95 | 0.04 | ◯ |
| 17 | Example | 0.4 | 99.4 | MnO | 0.6 | 0.96 | 0.02 | ◯ |
| 18 | Example | 0.4 | 99.4 | SrO | 0.6 | 0.95 | 0.04 | ◯ |
| 19 | Example | 0.4 | 99.2 | Y2O3 | 0.8 | 0.97 | 0.03 | ◯ |
| 20 | Example | 0.4 | 99.4 | ZrO2 | 0.6 | 0.95 | 0.02 | ◯ |
| 21 | Example | 0.4 | 99.4 | Nb2O5 | 0.6 | 0.94 | 0.04 | ◯ |
| 22 | Example | 0.4 | 99.3 | BaO | 0.7 | 0.94 | 0.04 | ◯ |
| 23 | Example | 0.4 | 99.3 | HfO2 | 0.7 | 0.95 | 0.05 | ◯ |
| 24 | Example | 0.4 | 99.4 | La2O3 | 0.6 | 0.96 | 0.03 | ◯ |
| 25 | Example | 0.4 | 99.4 | Gd2O3 | 0.6 | 0.96 | 0.03 | ◯ |
| 26 | Example | 0.4 | 99.4 | Tb4O7 | 0.6 | 0.96 | 0.03 | ◯ |
| 27 | Example | 0.4 | 99.4 | Dy2O3 | 0.6 | 0.96 | 0.03 | ◯ |
| 28 | Example | 0.4 | 99.4 | Ho2O3 | 0.6 | 0.96 | 0.03 | ◯ |
| 29 | Example | 0.4 | 99.4 | Er2O3 | 0.6 | 0.96 | 0.03 | ◯ |
| 30 | Example | 0.4 | 99.4 | Tm2O3 | 0.6 | 0.96 | 0.03 | ◯ |
| 31 | Example | 0.4 | 99.4 | Yb2O3 | 0.6 | 0.96 | 0.03 | ◯ |
| 32 | Example | 0.4 | 99.4 | Lu2O3 | 0.6 | 0.96 | 0.03 | ◯ |
| 33 | Example | 0.4 | 99.3 | CaTiO3 | 0.7 | 0.97 | 0.02 | ◯ |
| 34 | Example | 0.4 | 99.3 | SrTiO3 | 0.7 | 0.97 | 0.02 | ◯ |

Table 3 shows a thickness of a pre-fired internal electrode thin film 12a formed for each sample, a content ratio of nickel and added respective oxides explained above, capacitance, dielectric loss tan δ and evaluation on each sample.

As shown in Table 3, all of samples in the example, wherein the pre-fired internal electrode thin film 12a includes nickel as a conductive component and respective oxides explained above as a dielectric component and a content ratio of the oxides was respectively as shown in Table 3 (wt %), exhibited preferable results that the capacitance exceeded 0.9 μF and the dielectric loss tan δ became less than 0.01.

It was confirmed that as a result that a conductive component and a dielectric component were included in the pre-fired internal electrode thin film and a content of the dielectric component in the internal electrode thin film is larger than 0 wt % but not larger than 3 wt % with respect to the entire internal electrode thin film, spheroidizing in the internal electrode layers and breaking of electrodes were able to be prevented effectively and a decline of the capacitance could be suppressed even when the fired internal electrode layers were made thinner.

1. A production method of an electronic device for producing an electronic device including internal electrode layers and dielectric layers, comprising the steps of:
forming a pre-fired internal electrode thin film including a conductive component and a dielectric component;
stacking a green sheet to be a dielectric layer after firing and said pre-fired internal electrode thin film; and
firing a multilayer body of said green sheet and said pre-fired internal electrode thin film;
wherein a content of said dielectric component in said pre-fired internal electrode thin film is larger than 0 mol % but not larger than 0.8 mol % with respect to the entire pre-fired internal electrode thin film.

2. The production method of an electronic device as set forth in claim 1, wherein said dielectric component in said pre-fired internal electrode thin film includes at least one kind of BaTiO₃, Y₂O₃ and HfO₂.

3. A production method of an electronic device for producing an electronic device including internal electrode layers and dielectric layers, comprising the steps of:
forming a pre-fired internal electrode thin film including a conductive component and a dielectric component;
stacking a green sheet to be a dielectric layer after firing and said pre-fired internal electrode thin film; and
firing a multilayer body of said green sheet and said pre-fired internal electrode thin film;
wherein a content of said dielectric component in said pre-fired internal electrode thin film is larger than 0 wt % but not larger than 3 wt % with respect to the entire pre-fired internal electrode thin film.

4. The production method of an electronic device as set forth in claim 3, wherein:
said dielectric thin film in said pre-fired internal electrode thin film includes at least one kind of BaTiO₃, MgO, Al₂O₃, SiO₂, CaO, TiO₂, V₂O₃, MnO, SrO, Y₂O₃, ZrO₂, Nb₂O₅, BaO, HfO₂, La₂O₃, Gd₂O₃, Tb₄O₇, Dy₂O₃, Ho₂O₃, Er₂O₃, Tm₂O₃, Yb₂O₃, Lu₂O₃, CaTiO₃ and SrTiO₃.

5. The production method of an electronic device as set forth in claim 1, wherein a thickness of said pre-fired internal electronic thin film is 0.1 to 1.0 μm.

6. The production method of an electronic device as set forth in claim 1, wherein said pre-fired internal electronic thin film is formed by a thin film formation method.

7. The production method of an electronic device as set forth in claim 6, wherein said thin film formation method is the sputtering method, vapor deposition method or composite plating method.

8. The production method of an electronic device as set forth in claim 7, wherein said pre-fired internal electrode thin is formed by performing sputtering of a metal material and an inorganic material for composing said conductive component and said dielectric component at a time.

9. The production method of an electronic device as set forth in claim 8, wherein an inert gas is used as an introduction gas and a gas introduction pressure of said inert gas is 0.01 to 2 Pa when performing said sputtering.

10. The production method of an electronic device as set forth in claim 1, wherein a dielectric component included in said pre-fired internal electrode thin film and said green sheet include dielectric having substantially the same composition.

11. The production method of an electronic device as set forth in claim 1, wherein an average particle diameter of a dielectric component included in said pre-fired internal electrode thin film is 1 to 1 0 nm.

12. The production method of an electronic device as set forth in claim 1, wherein a conductive component included in said pre-fired internal electrode thin film is nickel and/or a nickel alloy as its main component.

13. The production method of an electronic device as set forth in claim 1, wherein said multilayer body is fired in an atmosphere having an oxygen partial pressure of 10⁻¹⁰ to 10⁻² Pa at a temperature of 1000° C. to 1300° C.

14. The production method of an electronic device as set forth in claim 1, wherein after firing said multilayer body, annealing is performed in an atmosphere having an oxygen partial pressure of 10⁻² to 100 Pa at a temperature of 1200° C. or lower.

15. An electronic device produced by any one of the methods as set forth in claim 1.

16. A production method of a multilayer ceramic capacitor having an element body, wherein internal electrode layers and dielectric layers are alternately stacked, comprising the steps of:
forming a pre-fired internal electrode thin film including a conductive component and a dielectric component;
alternately stacking green sheets to be dielectric layers after firing and said pre-fired internal electrode thin films; and
firing a multilayer body of said green sheets and said pre-fired internal electrode thin films;
wherein a content of said dielectric component in said pre-fired internal electrode thin film is larger than 0 mol % but not larger than 0.8 mol % with respect to the entire pre-fired internal electrode thin film.

17. A production method of a multilayer ceramic capacitor having an element body, wherein internal electrode layers and dielectric layers are alternatively stacked; comprising the steps of:
forming a pre-fired internal electrode thin film including a conductive component and a dielectric component;
alternately stacking green sheets to be dielectric layers after firing and said pre-fired internal electrode thin films; and
firing a multilayer body of said green sheets and said pre-fired internal electrode thin films;
wherein a content of said dielectric component in said pre-fired internal electrode thin film is larger than 0 wt % but not larger than 3 wt % with respect to the entire pre-fired internal electrode thin film.

18. A multilayer ceramic capacitor produced by either one of the methods as set forth in claim 16.
